(19) United States
(12) Patent Application Publication
(10) Pub. No.: US 2011/0038991 A1
(43) Pub. Date: Feb. 17, 2011

(54) SYSTEM FOR NUTRITIONALLY IMPROVING, PREPARING AND INTRODUCING INNOVATIONS INTO OILS FOR FOOD USE

(76) Inventor: Jose Antonio NOVEJARQUE CONDE, CATARROJA (Valencia) (ES)

Correspondence Address: KLAUBER & JACKSON, 411 HACKENSACK AVENUE, HACKENSACK, NJ, 07601, US

(21) Appl. No.: 12/857,534

(22) Filed: Aug. 16, 2010

Related U.S. Application Data
(63) Continuation of application No. PCT/ES2009/070119, filed on Apr. 27, 2009.

(30) Foreign Application Priority Data
May 22, 2008 (ES) P200801497

(51) Int. Cl. A23D 9/02; A23D 9/007

(52) U.S. Cl. 426/238; 426/601

(57) ABSTRACT

The invention relates to a method for nutritionally preparing oils for food use using natural and biological products and nutraceuticals, providing a system which is environmentally friendly and highly beneficial to the human body. The invention also relates to the production of oils using said method.

### CROSS REFERENCE TO RELATED APPLICATIONS

The present application is a Continuation of co-pending PCT Application No. PCT/ES2009/070119 filed Apr. 27, 2009, which in turn, claims priority from Spanish Application Serial No. P200801497 filed May 22, 2008. Applicant claims the benefits of 35 U.S.C. §120 as to the PCT application and priority under 35 U.S.C. §119 as to the said Spanish application, and the entire disclosures of both applications are incorporated herein by reference in their entireties.

### TECHNICAL FIELD OF THE INVENTION

The present invention relates to the food industry, particularly to obtaining enriched oils for human food use.

The novelty lies in obtaining oils enriched with natural products and nutraceuticals by means of a production process that adds such products to the treated oils. This process consists of three stages comprising the preparation of the natural product and/or product from biological agriculture, preparation of the selected nutraceuticals, and preparation of the end product by adding the former products to the required oil and macerating the mixture. This achieves oils with added nutritional characteristics superior to currently distributed oils.

### STATE OF THE TECHNIQUE

A legend tells how a cedar tree, cypress tree and olive tree were born on Adam's grave in the fields surrounding mount TABOR.

In Genesis, the dove that returned to the Ark to tell Noah that the flood had ended carried an olive branch in its beak.

Greek mythology tells of Zeus's promise to award possession of Attica to the divinity granting the most useful gift to its inhabitants. Athena, goddess of peace and wisdom triumphed by offering the olive tree and its oil as her gift, thus becoming the city's protector and planting the olive tree on the rock of the Acropolis.

Greeks introduced olive oil to Italy, then extending it to North Africa and subsequently to Spain and Portugal.

The Romans are to be thanked for advances made in the culture of olive oil and its expansion worldwide.

The system for obtaining olive oil is unique among vegetable oils, since it is extracted using purely mechanical means from the fresh flesh of the fruit. Ever since time immemorial, olive oil has been given taste by introducing spices and vegetables, including its maceration with exquisite and unique products such as truffles.

The nearest document to the state of the technique is Spanish patent ES 2169990, which describes adding Vitamin E to the receiving oil. The result is a final oil effectively enriched in this element, being limited this process to adding the element mechanically to the oil vat once the oil has been prepared. The main difference with the present invention is that the present invention treats products that have been mixed, homogenised, and macerated with the initial oil requiring a control process and results compatible with each type of oil. The present invention mixes, for the first time, fruits with oil maintaining the similar uses and organoleptic properties of the oil. Other publications forming part of the state of the technique include patent application ES 2017551, which describes a fish oil to which different components have been added for consumption as a nutritional supplement, or ES 2023544, which also describes the manufacture of a food product achieved from wheat germ oil.

### REFERENCES

UNE-EN ISO 14644: “Clean rooms and attached premises.”
ES 2169990: NARANJO M, “Procedure for obtaining extra virgin oil enriched with vitamin E”.
ES 2017551: AVIV H, “Edible product based on fish oil, lecithin, unsaturated oil and a cocoa or a similar type of binding agent”.
ES 2023544: MARCHAN S, “Procedure for manufacturing a food product based on wheat germ oil”.

### DESCRIPTION OF THE INVENTION

The present invention consists of a procedure for obtaining an oil enriched with selected natural products and nutraceuticals, of high quality and highly beneficial for humans. This procedure comprises the following stages:
PHASE A: Concentration of the Natural Products to be Added.

The natural products and/or products from biological agriculture are prepared. The preparation of the products is carried out in “clean rooms” equipped and fitted (UNE-EN ISO 14644) for the process. Inside the “clean rooms”, the natural product and/or product from biological agriculture to be used is selected and prepared. Between these products are included, among others, vegetables, fruit, spices, herbs, oily nuts, coffee, cocoa, chocolate, spice oleoresins, beehive products, fish and seafood, and their corresponding blends.

In a preferred embodiment of the invention, said fruit or vegetables, or spice oleoresins come from biological agriculture.

In another preferred embodiment of the invention, said herbs are tea, mate or mint.

Once selected, the product is weighed determining the required percentage in the end product. Next, it is introduced in a suitable stainless steel vat and the selected function required for processing and concentrating each food product is carried out. This process may involve grinding, pressing, concentrating, macerating, filtering or any other achieving such purpose.

Once the concentrate from the selected food product has been obtained the process continues by introducing the product in the stainless steel vat of the ultrasound device made of stainless steel specially designed for the purpose, and making it pass through the closed circuit for 20 to 65 minutes at a temperature between 10° C. and 30° C. A preferred embodiment is to make it pass through the closed circuit for 20 to 45 minutes at a temperature between 15° C. and 30° C.

Once this step of ultrasound fragmentation has been completed, the filtering of the product starts up, using a special tangential ceramic filter, bearing in mind the different procedures appropriate to the selected food product. Micro-filtration, ultra-filtration, nano-filtration or inverse osmosis are to be used as appropriate.
PHASE B: Preparation of the Selected Nutraceutical Products.

Next, the selected nutraceuticals chosen for the different types of oils or blends of the process will be prepared, weighing and mixing them until their complete homogenisation.

Different embodiments of the invention comprise as nutraceuticals sultana raisins, grain quinoa, golden flax seeds, saracen wheat, spelt grain, fine bulgur, textured soy protein, styrian pumpkin seeds, essential amino acids and vitamins.

In a preferred embodiment the fine bulgur is between 1-1.8 mm.

In another preferred embodiment of the invention, the vitamins are vitamin C or vitamin E.
PHASE C: Adding of Said Natural Products and Nutraceuticals to the Oil or Blend Until Complete Homogenisation, Followed by Mixing and Maceration.

The selected oil or blend is prepared and introduced in a stainless steel vat prepared for mixing and maceration. The concentrate of the food prepared in PHASE A is added until complete homogenisation in an approximate value of 5% of the total manufacture. Next the nutraceuticals are added and everything is mixed for 10 to 30 minutes. A preferred embodiment is to mix between 10 and 50 minutes. The mixture is macerated for 30 to 40 days at a temperature between 5° C. and 25° C.

Different embodiments of the invention comprise selecting the oil to be enriched from among sunflower oil, peanut oil, safflower oil, soy oil, corn germ oil, cotton oil, grape seed oil, olive oil, canola oil, almond oil, walnut oil, sesame oil and pumpkin seed oil, and their corresponding blends.

A preferred embodiment comprises said olive oil being selected from among the group comprising refined oil, extra virgin olive oil, or refined marc.

Another preferred embodiment of the invention comprises said extra virgin olive oil being of biological agriculture.

The most preferred embodiment of the present invention is the final oil enriched by the previous process.

### EXAMPLES

### Example 1

Mango fruit is selected, proceeding to prepare 500 kg for manufacture of the end product, carrying out the following steps:
PHASE A: Mango concentrate is prepared in a white room specially fitted out for the purpose following cleanliness standards. 3.5 kg of concentrate are mixed in 25 kg (5% of the total) sunflower oil.
PHASE B: Once the mixture has been homogenised, the following nutraceuticals are added: 1.5 kg of essential amino acids, 12 kg of sultana raisins and 6 kg of pumpkin seeds until complete homogenisation.
PHASE C: Mixing with 475 kg of sunflower oil in a stainless steel vat for 10 to 30 minutes. Maceration for 30 to 40 days at a temperature ranging between 5° C. and 25° C. Followed by packaging for distribution and sale.

### Example 2

### Blend (Nutraceuticals, Fruit and Oil)

Passion fruit (maracuya) is selected proceeding to prepare 100 kg of finished product by carrying out the following steps:
PHASE A: The passion fruit concentrate is prepared in a white room specially fitted out for the process under appropriate hygiene standards. 10 kg of passion fruit concentrate is mixed in 50 kg of extra virgin premium avocado oil.
PHASE B: Once the mixture has been homogenised, the following nutraceuticals are added: 1.67 kg of Aloe Vera and 100 grams of Zn until homogenisation.
PHASE C: Mixing in a stainless steel vat with 10 kg of extra virgin bio olive oil for a mixing time between 12 and 25 minutes. Maceration takes place during 10 days at a temperature between 5 and 25° C.

Followed by packaging for distribution and sale.

1. Procedure for obtaining enriched oil from natural products and nutraceuticals, wherein it comprises:
obtaining a concentrate of the natural products, subjecting said concentrate to ultrasound fragmentation and filtering the product obtained after ultrasound fragmentation,
preparing the nutraceuticals, and
adding said natural products and nutraceuticals to the oil or blend until their complete homogenisation,
followed by a stage of mixing and a stage of maceration.

2. Procedure according to claim 1, wherein obtaining the natural product concentrate is carried out by means of grinding, pressing, concentrating, macerating or filtering.

3. Procedure according to claim 1, wherein said ultrasound fragmentation is carried out for a time ranging between 20 and 65 minutes.

4. Procedure according to claim 1, wherein said ultrasound fragmentation is carried out at a temperature ranging between 10° C. and 30° C.

5. Procedure according to claim 1, wherein said filtering of the product obtained following ultrasound fragmentation is selected among micro-filtration, ultra-filtration, nano-filtration or inverse osmosis.

6. Procedure according to claim 1, wherein said natural products are selected among the group comprising vegetables, fruit, spices, herbs, oily nuts, coffee, cocoa, chocolate, spice oleoresins, beehive products, fish and seafood, and their corresponding blends.

7. Procedure according to claim 6, wherein said vegetables, fruit and spice oleoresins come from biological agriculture.

8. Procedure according to claim 6, wherein said herbs are selected among the group comprising tea, mate and mint.

9. Procedure according to claim 1, wherein said nutraceuticals are selected among the group comprising sultana raisins, grain quinoa, golden flax seeds, saracen wheat, grain spelt, fine bulgur, textured soy protein, styrian pumpkin seeds, essential amino acids and vitamins.

10. Procedure according to claim 9, wherein said fine bulgur is between 1-1.8 mm.

11. Procedure according to claim 9, wherein said vitamins are vitamin C or vitamin E.

12. Procedure according to claim 1, wherein said oil is selected between the group comprising sunflower oil, peanut oil, safflower, soy, corn germ, cotton, grape seed, olive oil, canola, almond, walnut, sesame and pumpkin seed oil, and their corresponding blends.

13. Procedure according to claim 12, wherein said olive oil is selected between the group comprising refined oil, extra virgin olive oil and refined marc.

14. Procedure according to claim 13, wherein said extra virgin olive oil comes from biological agriculture.

15. Procedure according to claim 1, wherein said stage of mixing lasts between 10 and 50 minutes.

16. Procedure according to claim 1, wherein said maceration is carried out for a time between 30 and 40 days.

17. Procedure according to claim 1, wherein said maceration is carried out at a temperature ranging between 5° C. and 25° C.

18. Enriched oil characterised in that it has been obtained according to the procedure of claim 1.
